(19) United States
(12) Patent Application Publication
(10) Pub. No.: US 2015/0331859 A1
(43) Pub. Date: Nov. 19, 2015

(54) METHOD AND SYSTEM FOR PROVIDING MULTIMEDIA CONTENT TO USERS BASED ON TEXTUAL PHRASES

(71) Applicant: Cortica, Ltd., TEL AVIV (IL)

(72) Inventors: Igal Raichelgauz, New York, NY (US); Karina Odinaev, New York, NY (US); Yehoshua Y. Zeevi, Haifa (IL)

(73) Assignee: Cortica, Ltd., TEL AVIV (IL)

(21) Appl. No.: 14/811,185

(22) Filed: Jul. 28, 2015

Related U.S. Application Data
(63) Continuation-in-part of application No. 14/643,694, filed on Mar. 10, 2015.
Application No. 14/643,694 is a continuation of application No. 13/766,463, filed on Feb. 13, 2013, now Pat. No. 9,031,999.
Application No. 13/766,463 is a continuation-in-part of application No. 13/602,858, filed on Sep. 4, 2012, now Pat. No. 8,868,619.
Application No. 13/602,858 is a continuation of application No. 12/603,123, filed on Oct. 21, 2009, now Pat. No. 8,266,185.
Application No. 12/603,123 is a continuation-in-part of application No. 12/084,150, filed on Apr. 7, 2009, now Pat. No. 8,655,801.
Application No. 12/603,123 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 12/603,123 is a continuation-in-part of application No. 12/348,888, filed on Jan. 5, 2009.
Application No. 12/348,888 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/603,123 is a continuation-in-part of application No. 12/538,495, filed on Aug. 10, 2009, now Pat. No. 8,312,031.
Application No. 12/538,495 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/195,863 is a continuation-in-part of application No. 12/348,888, filed on Jan. 5, 2009.
(60) Provisional application No. 62/030,075, filed on Jul. 29, 2014.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30

(52) U.S. Cl. CPC G06F 17/30023; G06F 17/30864

(57) ABSTRACT

A method and system for searching for multimedia content elements respective of a textual query are provided. The method includes receiving at least one textual query from a web browser; identifying at least one concept matching the at least one textual query; searching for at least one multimedia content element respective of the matching concept; and causing a display of the at least one multimedia content element on the web browser upon determination of a match.

### CROSS-REFERENCE TO RELATED APPLICATIONS

This application claims the benefit of U.S. provisional application No. 62/030,075 filed on Jul. 29, 2014. This application is also a continuation-in-part (CIP) of U.S. patent application Ser. No. 14/643,694, filed on Mar. 10, 2015, now pending. The Ser. No. 14/643,694 application is a continuation of U.S. patent application Ser. No. 13/766,463 filed on Feb. 13, 2013, now allowed. The Ser. No. 13/766,463 application is a continuation-in-part of U.S. patent application Ser. No. 13/602,858 filed on Sep. 4, 2012, now U.S. Pat. No. 8,868,619. The Ser. No. 13/602,858 application is a continuation of U.S. patent application Ser. No. 12/603,123 filed on Oct. 21, 2009, now U.S. Pat. No. 8,266,185. The Ser. No. 12/603,123 application is a continuation-in-part of:

(1) U.S. patent application Ser. No. 12/084,150 having a filing date of Apr. 7, 2009, now U.S. Pat. No. 8,655,801, which is the National Stage of International Application No. PCT/IL2006/001235 filed on Oct. 26, 2006, which claims foreign priority from Israeli Application No. 171577 filed on Oct. 26, 2005 and Israeli Application No. 173409 filed on Jan. 29, 2006;

(2) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a continuation-in-part of the above-referenced U.S. patent application Ser. No. 12/084,150;

(3) U.S. patent application Ser. No. 12/348,888 filed on Jan. 5, 2009, now pending, which is a continuation-in-part of the above-referenced U.S. patent application Ser. No. 12/084,150 and the above-referenced U.S. patent application Ser. No. 12/195,863; and (4) U.S. patent application Ser. No. 12/538,495 filed on Aug. 10, 2009, now U.S. Pat. No. 8,312,031, which is a continuation-in-part of the above-referenced U.S. patent application Ser. No. 12/084,150, the above-referenced U.S. patent application Ser. No. 12/195,863, and the above-referenced U.S. patent application Ser. No. 12/348,888. All of the applications referenced above are herein incorporated by reference.

### TECHNICAL FIELD

The present disclosure relates generally to search engines and more specifically to a search of multimedia content through a plurality of sources over the web to provide multimedia content elements to users.

### BACKGROUND

Web search engines can be used for searching for multimedia content over the World Wide Web. A web search query refers to a query that a user enters into a web search engine in order to receive content, such as multimedia content, as search results. As technology advances, web search engines are being utilized in more areas of the world.

Users of the web from all around the world naturally enter different search queries when using search engines. Specifically, the search of multimedia content (e.g., images or video clips) is performed by providing a textual query. Consequently, the task of finding relevant and appropriate multimedia content elements using such queries has become increasingly complex, for example, due to language differences and different sentiments users may be using in order to describe the required search results. Furthermore, a user often seeks multimedia content, but cannot accurately express the objective of the search when using a textual query. Consequently, the user may be required to refine the search queries time after time until hitting relevant results.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor delineate the scope of any or all embodiments. Its sole purpose is to present some embodiments of one or more embodiments in a simplified form as a prelude to the more detailed description that is presented later. For convenience, the term some embodiments may be used herein to refer to a single embodiment or multiple embodiments of the disclosure.

Certain embodiments include a method for searching for multimedia content elements respective of a textual query. The method comprises: receiving at least one textual query from a web browser; identifying at least one concept matching the at least one textual query; searching for at least one multimedia content element respective of the matching concept; and causing a display of the at least one multimedia content element on the web browser upon determination of a match.

Certain embodiments also include a system for searching for multimedia content elements respective of a textual query. The system comprises: a processing unit; and a memory coupled to the processing unit, the memory containing instructions that when executed by the processing unit configures the system to: receive at least one textual query from a web browser; identify at least one concept matching the at least one textual query; search for at least one multimedia content element respective of the matching concept; and cause a display of the at least one multimedia content element on the web browser upon determination of a match.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a networked system utilized to describe the various disclosed embodiments.

FIG. 2 is a flowchart describing a process for providing multimedia content elements responsive to textual phrases according to one embodiment.

FIG. 3 is a diagram depicting the basic flow of information in the signature generator system.

FIG. 4 is a diagram showing the flow of patches generation, response vector generation, and signature generation in a large-scale speech-to-text system.

### DETAILED DESCRIPTION

It is important to note that the embodiments disclosed herein are merely examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

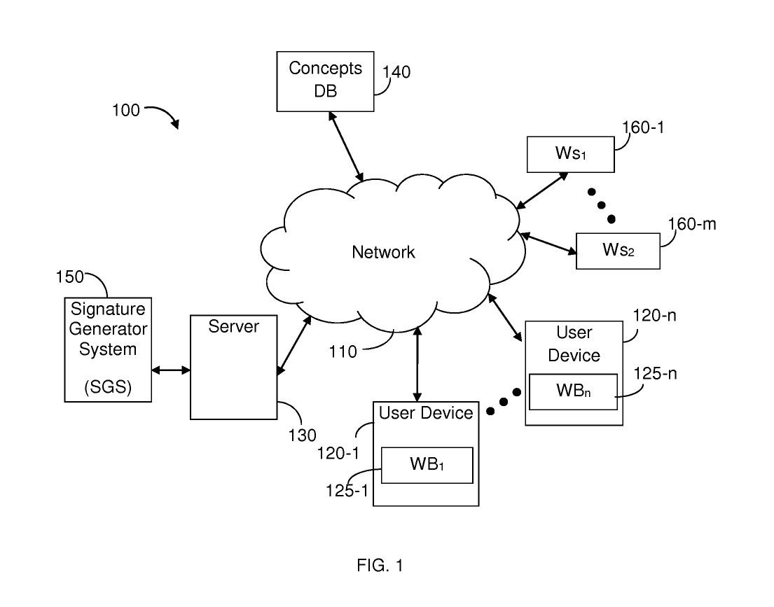

FIG. 1 shows an exemplary and non-limiting schematic diagram of a networked system 100 utilized to describe the various embodiments herein. As illustrated in FIG. 1, a network 110 is configured to enable the communication between different parts of the system 100. The network 110 may be the Internet, the world-wide-web (WWW), a local area network (LAN), a wide area network (WAN), a metro area network (MAN), and other networks capable of enabling communication between the elements of the system 100.

Further connected to the network 110 are client applications, such as web browsers (WB) 125-1 through 125-n (collectively referred to hereinafter as web browsers 125 or individually as a web browser 125). A web browser 125 is executed over a user device 120 which may be, for example, a personal computer (PC), a personal digital assistant (PDA), a smart phone, a mobile phone, a tablet computer, a wearable computing device, and the like. The user device 120 is configured to at least send queries (submitted or entered by a user of the user device 120) to a server 130 connected to the network 110. In an embodiment, the queries are textual phrases submitted with a purpose of searching for multimedia content elements. A multimedia content element is an image, graphics, a video stream, a video clip, an audio stream, an audio clip, a video frame, a photograph, images of signals, and portions thereof.

The networked system 100 also includes a plurality of web sources 160-1 through 160-m (collectively referred to hereinafter as web sources 160 or individually as a web source 160) connected to the network 110. Each of the web sources 160 may be, for example, a web server, a data repository, a database, and the like. The server 130 is also configured to search the one or more web sources 160 based on an input textual search query. The search results may be sent to the web browser 125 of the user device 120.

The various embodiments disclosed herein are realized using the server 130, a concepts database 140 and a signature generator system (SGS) 150. The server 130 is configured to receive at least a textual phrase query by means of a web browser 125. In an alternate embodiment, a user can provide an input textual phrase to perform the search for multimedia content elements through a website that enables receiving textual search queries and sending the multimedia content elements to the server 130.

The server 130 is configured to then query the concepts database 140 to identify at least one concept respective of the textual phrase. In an alternate embodiment, the server 130 is configured to analyze the received textual query, or portions thereof, to detect at least one concept in the concepts database 140 respectively. The concepts may be identified based on a determination that they appear in association with the textual phrase above a predetermined threshold. The associations may be predetermined and saved in the concepts database 140.

A concept is a collection of signatures representing elements of unstructured data and metadata describing the concept. Each concept is represented by one or more signature reduced clusters (SRCs). As a non-limiting example, a ‘Superman concept’ is a signature reduced cluster (SRC) of signatures describing elements (such as multimedia content elements) related to, e.g., a Superman cartoon: a set of metadata representing textual representation of the Superman concept such as a red cape, an “5”, and the name Clark Kent. Techniques for generating concepts and concept structures are also described in U.S. Pat. No. 8,266,185 to Raichelgauz, et al., which is assigned to common assignee, and is incorporated hereby by reference for all that it contains.

An exemplary database of concepts is disclosed in U.S. Pat. No. 9,031,999, filed Feb. 13, 2013, also assigned to common assignee, and is hereby incorporated by reference for all the useful information it contains.

In a non-limiting example, a user may enter a textual query for “super heroes.” Concepts associated with the query may include “Superman”, “Batman”, and the like. In another non-limiting example, a user may enter a textual query for “healthy recipes.” Concepts associated with the query may include “kale”, “quinoa”, and “fruit.”

In one embodiment, the search for matching concepts (or concept structures) is executed by comparing the received textual phrase to a metadata associated with each concept. As the metadata is also in a text format, such comparison is a textual based comparison. Metadata and a textual phrase are considered matching if they overlap more than a predetermined threshold level, e.g., 50%.

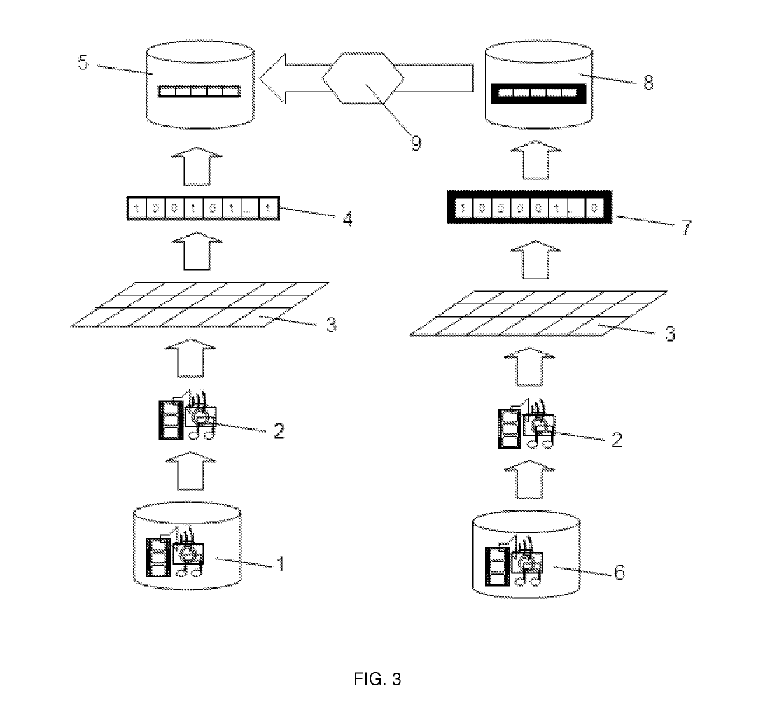

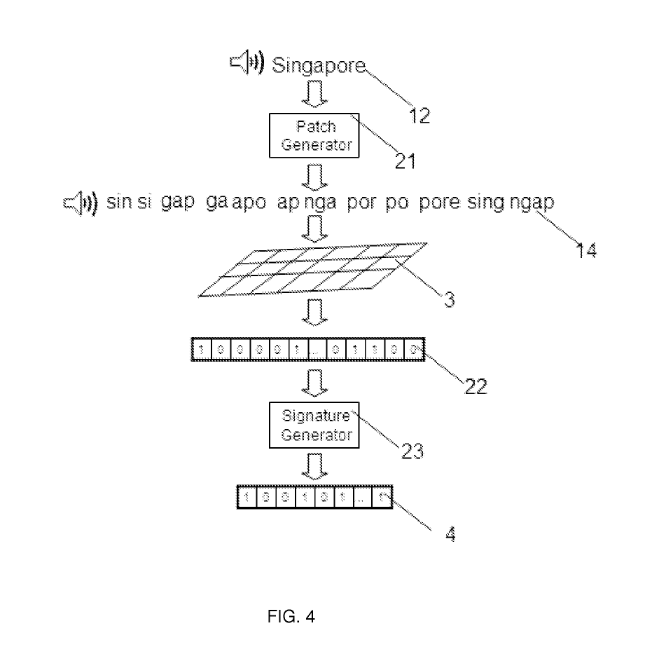

In another embodiment, the search for matching concepts is based on matching signatures. In this embodiment, at least one signature is generated for the received textual phrase. The generated signature is compared to SRCs of the concepts maintain in the database 140. Two signatures are considered matching if they overlap more than a predetermined threshold level, e.g., 55%. The values of the different thresholds may be the same or different. The generated signature(s) may be robust to noise and distortions as discussed below. The process for generating the signatures and matching is explained in more detail herein below with respect to FIGS. 3 and 4.

In an embodiment, multimedia content elements associated with the matching concept are retrieved, by the server 130, from the concept database 140. In such an embodiment, the concept database includes an index for generating at least one index for mapping the multimedia content elements to their respective concepts.

In another embodiment, the SRC of the matching concept is utilized to search the plurality of web sources 160. According to this embodiment, for each multimedia content element encountered during the search at least one signature is generated by the SGS 150. If the SRC of the concept and of the multimedia content element match above a predetermined threshold, the multimedia content element is included in the search results. The search is performed by means of the server 130.

It should be appreciated that using signatures to search for multimedia content elements allows for the retrieval and reorganization of accurate results including, but not limited to, multimedia elements in comparison to utilization of metadata. The signatures generated by the SGS 150 for the concepts allow for recognition and classification of the found multimedia elements, such as, content-tracking, video filtering, multimedia taxonomy generation, video fingerprinting, speech-to-text, audio classification, element recognition, video/image search and any other application requiring content-based signatures generation and matching for large content volumes such as web and other large-scale databases. For example, a signature generated by the SGS 150 for a picture showing a car enables accurate recognition of the model of the car from any angle from which the picture was taken.

In one embodiment, the server 130 is further configured to filter the results based in part on the signature(s) generated for each multimedia content element encountered during the search. Only the signatures that match the SRC of the matching concept over a predefined threshold are included in the search (filtered) results. This threshold would define the sensitivity of the search, i.e., a higher value of the threshold would return fewer results than a lower value.

Alternatively or collectively, the search results are filtered by the server 130, so that results would best serve the user providing the textual query. The filtering of results may be performed based on the user's intent or user activity. The user intent can be derived by the server 130 using, for example, the user's experience or at least one similar user's experience. The user activity can be tracked by an add-on (not shown) installed in the web browser 125.

The filtered results are sent to the web browser 125 for display thereon. The search results may be received, at the web browser 125, as a file or a link to a location of the multimedia content. The search results may be displayed on a display of the user device 120.

In some configurations, the server 130 and the SGS 150 comprise a processing unit, such as a processor that is coupled to a memory. The processing unit may include one or more processors. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit may be coupled to the memory. In an embodiment, the memory contains instructions that when executed by the processing unit results in the performance of the methods and processes described herein below. Specifically, the processing unit may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing unit to perform the various functions described herein. In some configurations, the processing unit may include an array of computational cored configured as discussed in detail below.

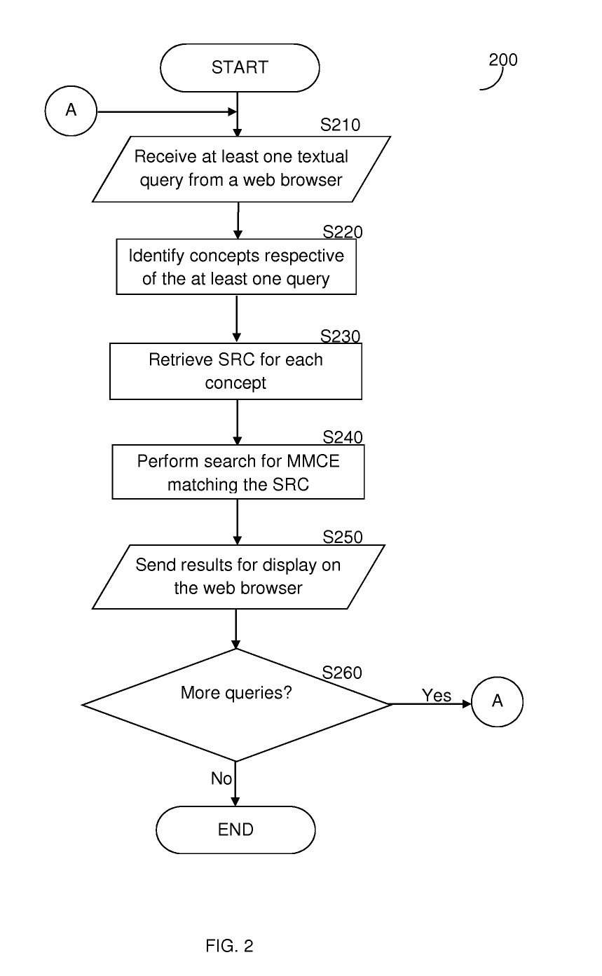

FIG. 2 depicts an exemplary and non-limiting flowchart 200 describing a method for providing multimedia content elements to users based on textual phrases according to an embodiment. The method may be performed by the server 130. Without limiting the scope of the disclosed embodiment, the method will be discussed with reference to the various elements shown in FIG. 1. In S210, at least one textual query from the web browser 125, is received by the server 130. The query may be a textual phrase received from a user of the web browser 125 through a user device 120.

In S220, at least one concept matching the received textual phrase of the query is identified. The search for matching concept is performed against the concept database as discussed in detail below. As noted above, a concept is a collection of signatures representing elements of unstructured data and metadata describing the concept. Each concept is associated with at least one SRC.

In S230, the SRC (a signature representing the concept) and/or metadata of the matching concept is retrieved.

In S240, a search for multimedia content elements matching the SRC is performed. At least one signature is input to the server 130 to enable a search for multimedia content elements through one or more web sources 160. For each multimedia content element encountered during the search at least one signature is generated. If the SRC of the concept and of the multimedia content element match above a predetermined threshold, the multimedia content element is included in search results.

In another embodiment, the search results are then filtered by the server 130 so that they would best serve the user providing the textual query. The filtering of results may be performed based on the user's intent or user activity. The user intent can be derived by the server 130 using, for example, the user's experience or at least one similar user's experience. The user activity can be tracked by an add-on (not shown) installed in the web-browser 125. The add-on is configured to track the users' activity.

Alternatively or collectively, the search results may be filtered based in part on the signature(s) generated for each multimedia content element encountered during the search. Only the signatures that match the SRC of the matching concept over a predefined threshold are included in the search (filtered) results. This threshold would define the sensitivity of the search, i.e., a higher value of the threshold would return fewer results than a lower value.

In an embodiment, S240 includes retrieving, from the concept database 140, multimedia content elements associated with each matching concept. In such an embodiment, the concept database 140 includes indexes for mapping the multimedia content elements to their respective concepts. In yet another embodiment, the search for content items through the web sources 160 may be performed using the metadata of the matching concept. For example, such a metadata serves as search (textual query).

In yet another embodiment, the search for content items through the web sources 160 may be performed using the metadata of the matching concept. For example, such a metadata serves a search (textual query).

In S250, the results are sent to the web browser 125 for display thereon. The search results may be received, at the web browser 125, as a file or a link to a location of the multimedia content. The search results may be displayed on a display of the user device 120. In S260 it is checked whether an additional query is received as a search query, and if so, execution continues with S210; otherwise, execution terminates.

Following is a non-limiting example for operation of the method described in FIG. 2. The server 130 receives a textual query “super heroes” from the web browser 125 over the network 110. The server 130 then identifies a plurality of concepts from the concepts database 140 that matches the query, for example, the concepts Superman and Batman. The server 130 then retrieves an SRC respective of each of the concepts. The server 130 then searches through the web sources 160 for multimedia content that matches the SRC and provides the search results to the web browser 125. According to an embodiment, the search results may be filtered by the server 130 in order display meaningful search results.

Following is another non-limiting example for operation of the disclosed embodiments. The server 130 receives a textual query “super heroes” from the web browser 125 over the network 110. The server 130 also receives the user activity derived by an add-on tracking the user activity and determines the user's intent to be “gaming.” The server 130 then identifies a plurality of concepts from the concepts database 140 that matches the query, for example, the concepts Superman and Batman. The server 130 then retrieves an SRC respective of each of the concepts. The server 130 then searches through the web sources 160 for multimedia content that matches the SRC and filters the results based on the user's intent to only show gaming related results. The server provides the filtered search results to the web browser 125.

FIGS. 3 and 4 illustrate the generation of signatures for the multimedia content by the SGS 150 according to one embodiment. An exemplary high-level description of the process for large scale matching is depicted in FIG. 3. In this example, the matching is for a video content.

Video content segments 2 from a Master database (DB) 6 and a Target DB 1 are processed in parallel by a large number of independent computational cores 3 that constitute an architecture for generating the signatures (hereinafter the “Architecture”). Further details on the computational cores generation are provided below. The independent cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures 4 are effectively matched, by a matching algorithm 9, to Master Robust Signatures and/or Signatures 7 database to find all matches between the two databases.

To demonstrate an example of signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames.

The signatures' generation process is now described with reference to FIG. 4. The first step in the process of signatures generation from a given speech-segment is to break down the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 130 and SGS 150. Thereafter, all the K patches are injected in parallel into all computational cores 3 to generate K response vectors 22, which are fed into a signature generator system 23 to produce a database of Robust Signatures and Signatures 4.

In order to generate Robust Signatures, i.e., signatures that are robust to additive noise L (where L is an integer equal to or greater than 1) by the computational cores 3, a frame ‘i’ is injected into all the cores 3. Then, cores 3 generate two binary response vectors: \vec{S} which is a signature vector, and \vec{RS} which is a Robust Signature vector.

For generation of signatures robust to additive noise, such as White-Gaussian-Noise, scratch, etc., but not robust to distortions, such as crop, shift and rotation, etc., a core Cᵢ={nᵢ} (1≦i≦L) may consist of a single leaky integrate-to-threshold unit (LTU) node or more nodes. The node nᵢ equations are:

$${V}_{i} = {\sum }_{j} {w}_{ij} {k}_{j}$$

$${n}_{i} = Π ( Vi - {Th}_{x} )$$

where, Π is a Heaviside step function; wᵢⱼ is a coupling node unit (CNU) between node i and image component j (for example, grayscale value of a certain pixel j); kⱼ is an image component ‘j’ (for example, grayscale value of a certain pixel j); Thx is a constant Threshold value, where x is ‘S’ for signature and ‘RS’ for Robust Signature; and Vi is a Coupling Node Value.

The Threshold values Th_{X} are set differently for signature generation and for Robust Signature generation. For example, for a certain distribution of values (for the set of nodes), the thresholds for signature (Th_{S}) and Robust Signature (Th_{RS}) are set apart, after optimization, according to at least one or more of the following criteria:

For: Vᵢ>Th_{RS}

1−p(V>Th_{S})−1−(1−ε)^{l}<<1 1:

That is, given that l nodes (cores) constitute a Robust Signature of a certain image I, the probability that not all of these I nodes will belong to the signature of a same, but noisy image, Ĩ is sufficiently low (according to a system's specified accuracy).

p(Vᵢ>Th_{RS})≈l/L 2:

i.e., approximately l out of the total L nodes can be found to generate a Robust Signature according to the above definition.

3: Both Robust Signature and Signature are Generated for Certain Frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the signature generation can be found U.S. Pat. Nos. 8,326,775 and 8,312,031, assigned to common assignee, is hereby incorporated by reference for all the useful information it contains.

A computational core generation is a process of definition, selection, and tuning of the parameters of the cores for a certain realization in a specific system and application. The process is based on several design considerations, such as:
(a) The cores should be designed so as to obtain maximal independence, i.e., the projection from a signal space should generate a maximal pair-wise distance between any two cores' projections into a high-dimensional space.
(b) The cores should be optimally designed for the type of signals, i.e., the cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.
(c) The cores should be optimally designed with regard to invariance to a set of signal distortions, of interest in relevant applications.

Detailed description of the computational core generation and the process for configuring such cores is discussed in more detail in U.S. Pat. No. 8,655,801 referenced above.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiments and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for searching for multimedia content elements respective of a textual query, comprising:
receiving at least one textual query from a web browser;
identifying at least one concept matching the at least one textual query;
searching for at least one multimedia content element respective of the matching concept; and
causing a display of the at least one multimedia content element on the web browser upon determination of a match.

2. The method of claim 1, wherein a concept is a collection of signatures representing multimedia content elements of unstructured data and metadata describing the concept, wherein the concept is represented by at least one signature reduced cluster (SRC).

3. The method of claim 2, wherein the at least one concept is identified in a concepts database.

4. The method of claim 2, wherein identifying the at least one matching concept further comprises:
generating at least one signature for the textual query; and
comparing the at least one generated signature to SRCs of concepts stored in the concepts database, wherein a concept having a SRC that matches the at least one generated signature is determined to be a matching concept.

5. The method of claim 2, wherein searching for the at least one multimedia content element further comprises:
retrieving at least a SRC of the matching concept; and
searching through a plurality of web sources for the at least one multimedia content that matches the retrieved SRC.

6. The method of claim 5, further comprising:
generating a signature for each multimedia content element detected through the search;
matching each generated signature to the SRC; and
including each multimedia content element with a signature matching the SRC above a predetermined threshold in the search results.

7. The method of claim 2, wherein searching for the at least one multimedia content element further comprises:
retrieving the at least one multimedia content element associated with the matching concept.

8. The method of claim 2, wherein searching for the at least one multimedia content element further comprises:
retrieving at least a metadata of the matching concept; and
searching through a plurality of web sources for the at least one multimedia content using the metadata.

9. The method of claim 1, further comprising:
filtering the search results based on at least one of: a user intent and user activity.

10. The method of claim 9, wherein the user intent is derived using at least one of: the user's experience, at least one similar user's experience.

11. The method of claim 9, wherein the user activity is tracked by an add-in installed on the web browser.

12. The method of claim 1, wherein the at least one multimedia content is at least one of: an image, graphics, a video stream, a video clip, an audio stream, an audio clip, a video frame, a photograph, images of signals, and portions thereof.

13. A non-transitory computer readable medium having stored thereon instructions for causing one or more processing units to execute the method according to claim 1.

14. A system for searching for multimedia content elements respective of a textual query, comprising:
a processing unit; and
a memory coupled to the processing unit, the memory containing instructions that when executed by the processing unit configures the system to:
receive at least one textual query from a web browser;
identify at least one concept matching the at least one textual query;
search for at least one multimedia content element respective of the matching concept; and
cause a display of the at least one multimedia content element on the web browser upon determination of a match.

15. The system of claim 1, wherein a concept is a collection of signatures representing multimedia content elements of unstructured data and metadata describing the concept, wherein the concept is represented by at least one signature reduced cluster (SRC).

16. The system of claim 15, wherein the at least one concept is identified in a concepts database.

17. The system of claim 15, wherein the system is further configured to:
generate at least one signature for the textual query; and
compare the at least one generated signature to SRCs of concepts stored in the concepts database, wherein a concept having a SRC that matches the at least one generated signature is determined to be a matching concept.

18. The system of claim 15, wherein the system is further configured to:
retrieve at least a SRC of the matching concept; and
search through a plurality of web sources for the at least one multimedia content that matches the retrieved SRC.

19. The system of claim 18, wherein the system is further configured to:
generate a signature for each multimedia content element detected through the search;
match each generated signature to the SRC; and
include each multimedia content element with a signature matching the SRC above a predetermined threshold in the search results.

20. The system of claim 15, wherein the system is further configured to:
retrieve the at least one multimedia content element associated with the matching concept.

21. The system of claim 15, wherein the system is further configured to:
retrieve at least a metadata of the matching concept; and
search through a plurality of web sources for the at least one multimedia content using the metadata.

22. The system of claim 14, wherein the system is further configured to:
filter the search results based on at least one of: a user intent and user activity.

23. The system of claim 22, wherein the user intent is derived using at least one of: the user's experience, at least one similar user's experience.

24. The system of claim 22, wherein the user activity is tracked by an add-in installed on the web browser.

25. The system of claim 14, wherein the at least one multimedia content is at least one of: an image, graphics, a video stream, a video clip, an audio stream, an audio clip, a video frame, a photograph, images of signals, and portions thereof.
